(19) United States
(12) Patent Application Publication
(10) Pub. No.: US 2007/0094035 A1
(43) Pub. Date: Apr. 26, 2007

(54) Audio coding

(75) Inventor: Adriana Vasilache, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/256,670

(22) Filed: Oct. 21, 2005

(51) Int. Cl. G10L 21/00

(52) U.S. Cl. 704/500

(57) ABSTRACT

An audio coding method is described that includes receiving an input audio signal, splitting the input audio signal into at least two sub-bands, downscaling the at least two sub-band with a factor depending at least on a standard deviation of the corresponding sub-band, companding each of the at least downscaled sub-bands, and quantizing the companded, downscaled sub-bands with a lattice quantizer.

### TECHNICAL FIELD

The application relates in general to audio encoding and decoding technology.

### BACKGROUND OF THE INVENTION

For audio coding, different coding schemes have been applied in the past. One of these coding schemes applies a psychoacoustical encoding. With these coding schemes, spectral properties of the input audio signals are used to reduce redundancy. Spectral components of the input audio signals are analyzed and spectral components are removed which apparently are not recognized by the human ear. In order to apply these coding schemes, spectral coefficients of input audio signals are obtained.

Quantization of the spectral coefficients within psychoacoustical encoding, such as Advanced Audio Coder (AAC) and MPEG audio, was previously performed using scalar quantization followed by entropy coding of the scale factors and of the scaled spectral coefficients. The entropy coding was performed as differential encoding using eleven possible fixed Huffman trees for the spectral coefficients and one tree for the scale factors.

The ideal coding scenario produces a compressed version of the original signal, which results in a decoding process in a signal that is very close (at least in a perceptual sense) to the original, while having a high compression ratio and a compression algorithm that is not too complex. Due to today's widespread multimedia communications and heterogeneous networks, it is a permanent challenge to increase the compression ratio for the same or better quality while keeping the complexity low.

### SUMMARY OF THE INVENTION

According to one aspect, the application provides a method for audio encoding comprising receiving an input audio signal, splitting the input audio signal into at least two sub-bands, scaling the at least two sub-bands with a first factor, companding each of the at least two scaled sub-bands, and quantizing the companded, scaled sub-bands.

According to another aspect, the application provides an encoder comprising a transform unit adapted to receive an input audio signal and to split the input audio signal into at least two sub-bands, a scaling unit adapted to scale at least two sub-bands with a first factor, a companding unit adapted to compand each of at least two scaled sub-bands; and a quantization unit adapted to quantize the companded, scaled sub-bands

According to another aspect, the application provides an electronic device comprising the same components as the presented encoder.

According to another aspect, the application provides a software program product storing a software code in a readable memory, which is adapted to realize the presented encoding method when being executed in a processing unit of an electronic device.

According to one other aspect, the application provides a method for audio decoding comprising receiving encoded audio data, generating at least two companded sub-bands from said encoded audio data, decompanding each companded sub-band, scaling the at least two decompanded sub-bands with a first factor, and combining the decompanded and scaled sub-bands to a decoded audio signal.

According to another aspect, the application provides a decoder comprising a decompanding unit adapted to decompand at least two companded sub-bands, wherein said companded sub-bands are generated from received encoded audio data, a scaling unit adapted to scale the at least two decompanded sub-bands with a first factor, and a transform unit adapted to combine the decompanded and scaled sub-bands to a decoded audio signal.

According to another aspect, the application provides a software program product storing a software code in a readable memory, which is adapted to realize the presented decoding method when being executed in a processing unit of an electronic device.

According to another aspect, the application provides an electronic device comprising the same components as the presented decoder.

According to another aspect, the application provides a system comprising the presented encoder and the presented decoder.

The application provides companding spectral components of the input audio signal sub-bands prior to vector quantization of the spectral data. According to one aspect, the companding takes into account the distribution of the spectral coefficients and psychoacoustical phenomena of the input audio signal by using scaled sub-bands, which scaled sub-bands enable a performance-complexity efficient quantization.

According to one embodiment, the scaling comprises scaling the at least two sub-bands with a first scaling factor. This first scaling factor may depend for example on the total available bitrate for an encoded data stream, on the available bitrate for each subband, and/or on properties of a respective sub-band. The first scaling factor may comprise for instance a base and an exponent. The total bitrate may be set for example by a user, which may then be distributed automatically in a suitable manner to the subbands.

The base for a respective sub-band may then be set for example to a lower value if the overall bitrate, which may be imposed by the user, has higher values, and to a higher value if the bitrate imposed by the user has lower values.

The exponent may be determined for each sub-band for example such that the total bitrate of the encoded audio signal is as close as possible, but possibly not less than an available bitrate and that an overall distortion in all sub-bands is minimized. This allows optimizing a bitrate-distortion measure.

The exponent may be determined in various ways. The lowest considered exponent for each sub-band may be computed for instance depending on the allowed distortion for this sub-band.

For the decoding of the encoded audio signal, information about the scaling at the encoding side has to be available at the decoding side as well. To this end, the required information may be encoded, for instance entropy encoded. It may be sufficient to provide and encode only a part of the first scaling factor. The overall bitrate set by the user is known both at the encoder and at the decoder side, therefore it may be sufficient to encode only the exponent and not the base.

According to a further embodiment, the scaling can comprise a second factor depending on the standard deviation of the sub-bands scaled by the first factor. The scaling with the first scaling factor may replace scaling with the second scaling factor.

According to a further embodiment, the probability function of the scaled sub-bands is utilized for creating a cumulative density function for companding. The spectral data can be approximated as having the probability density function of a generalized Gaussian with shape factor 0.5. This observation could enable the use of the analytic generalized Gaussian probability density function to compute the cumulative density function and obtain the companding function in a conventional manner. This is a classic method known as ‘histogram equalization’. The idea is to transform the data such that the probability density function of the resulting transformed data should be uniform. The transform function is shown to be given by the cumulative density function of the data. The cumulative density function is a non-descending function whose maximum is 1. It can be predetermined off-line and stored at the encoding end, and a corresponding function can be predetermined and stored for each sub-band at the decoding end.

According to another embodiment, the companded sub-bands are scaled before quantization with a third scaling factor. This third scaling factor may be higher for higher overall bitrates than for lower overall bitrates. This third factor may depend on the standard deviation of the sub-band coefficients, therefore with such a multiplication, a further means is provided for adjusting the quantization resolution separately for each sub-band. The lattice quantizer may use for instance a rectangular truncated lattice for quantizing the companded, scaled sub-bands, resulting in a codevector for each sub-band.

For each sub-band, a dedicated norm may be calculated for the lattice truncation, which includes the quantized sub-band. The norm for the rectangular truncated lattice for each sub-band may be selected to correspond to the norm of the respective codevector. As such a norm cannot be known beforehand at the decoding end, it may be encoded, for instance entropy encoded, so that it may be provided as further side information for the encoded audio signal.

The codevectors resulting in the quantization may be encoded for instance by indexing.

The presented coding options can be applied for instance, though not exclusively, within an AAC coding framework.

Further aspects of the application will become apparent from the following description, illustrating possible embodiments.

### BRIEF DESCRIPTION OF THE DRAWINGS

FIG. 1 illustrates schematically functional blocks of an encoder of a first electronic device according to an embodiment of the invention;

FIG. 2 illustrates schematically functional blocks of encoder components according to embodiments;

FIG. 3 is a flow chart illustrating an encoding operation according to an embodiment of the invention;

FIG. 4 illustrates schematically functional blocks of a decoder of a second electronic device according to an embodiment of the invention;

FIG. 5 illustrates schematically functional blocks of decoder components according to embodiments.

### DETAILED DESCRIPTION

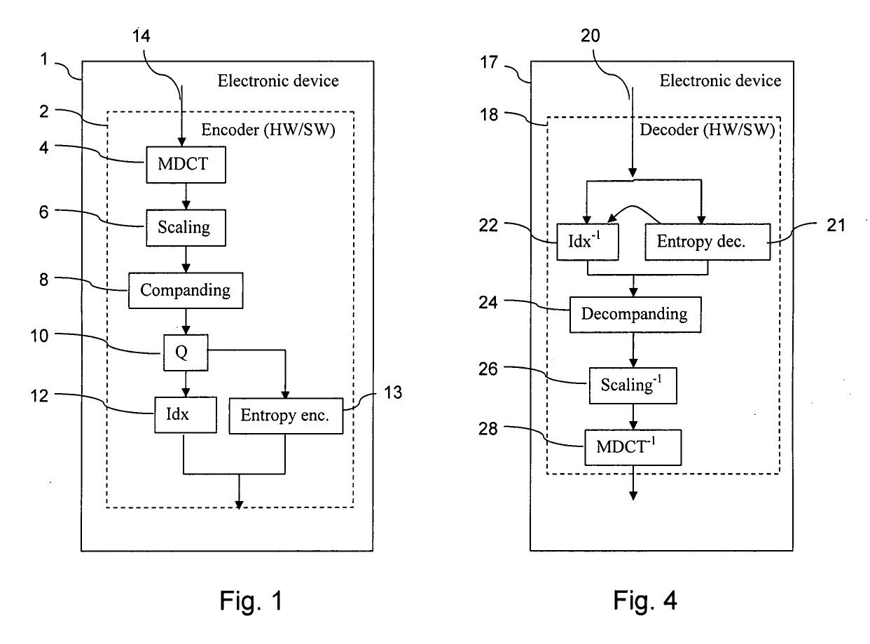

FIG. 1 is a diagram of an exemplary electronic device 1, in which a low-complexity encoding according to an embodiment of the invention may be implemented.

The electronic device 1 comprises an encoder 2, of which the functional blocks are illustrated schematically. The encoder 2 comprises a modified discrete cosine transform (MDCT) unit 4, a scaling unit 6, a companding unit 8, a quantization unit 10, an indexing unit 12 and an entropy encoding unit 13.

Within the MDCT unit 4 an input audio signal 14 is MDCT transformed into the frequency domain. Then, within the scaling unit 6, the spectral components of a plurality of frequency sub-band of the frequency domain signal are scaled with a respective scaling factor. This scaling can, for example, be a downscaling with a first and/or a second scaling factor.

These scaled spectral components of the sub-bands are provided to companding unit 8, within which the spectral components are companded. The companded spectral components are provided to quantization unit 10, in which the companded spectral components are multiplied by a third scaling factor and quantized using a lattice quantizer. The scaling may be carried out outside the quantization unit 10. If the Zn lattice is used this step corresponds to rounding to nearest integer to obtain quantized spectral components. The quantized spectral components of each sub-band can be represented by a respective lattice vector.

The obtained integer lattice vector can be indexed through a suitable indexing method for each sub-band in indexing unit 12.

The encoder 2 can be implemented in hardware (HW) and/or software (SW). As far as implemented in software, a software code stored on a computer readable medium realizes the described functions when being executed in a processing unit of the device 1.

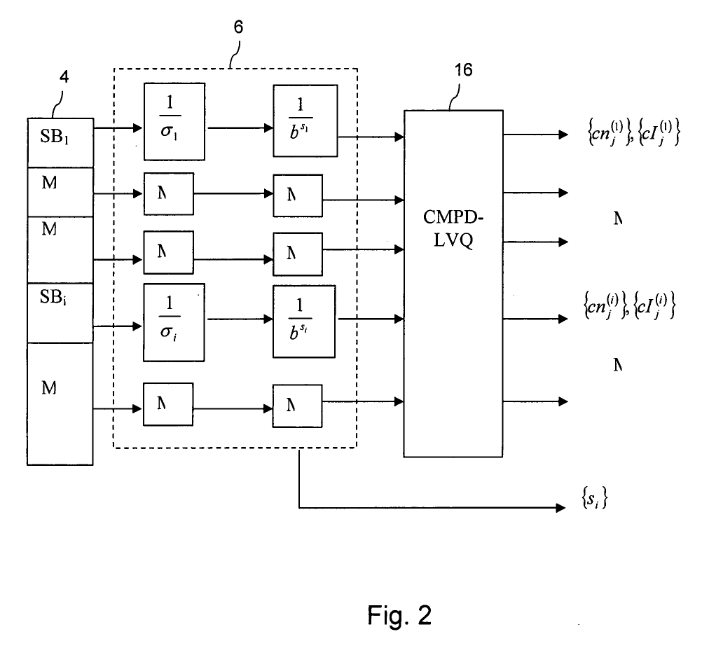

Embodiments of the new structure for very low complexity quantization of the MDCT spectral coefficients of audio signals will now be described in more detail with reference to FIG. 2. Illustrated are an MDCT unit 4, a modified scaling unit 6 and a companding lattice vector quantizer unit 16. The companding lattice vector quantizer unit 16 includes the companding unit 8, the quantization unit 10 and the indexing unit 12 of FIG. 1.

Each sub-band SBᵢ, with i=1 to N, provided by the MDCT unit 4 is, according to embodiments, scaled within scaling unit 6 with a scale factor 1/b^{s}^{ᵢ}, and with the inverse of the scaled sub-band standard deviation 1/σᵢ. Since the value of the standard deviation may only be estimated off-line from a training set, the variance value of the scaled sub-band components may be different from 1. However, the better the estimation is, the closer is the variance value equal to 1.

The division by the standard deviation for the data already scaled with the first scaling factor makes the scaled data to have a variance of ‘1’.

The base b used for the calculation of the scale factors depends on the available bitrate, which may be set by the user. For bitrates higher or equal 48 kBit/s this base b can be 1.45, and for bitrates lower than 48 kBit/s, the base b can be 2. It is to be understood that other values could be chosen as well, if found to be appropriate. The use of different base values allows for different quantization resolutions at different bitrates. The determination of the exponents {sᵢ} used for the calculation of the scale factors for each sub-band, which may be integers from 0 to 42, will be described further below.

The standard deviation and the base b for each sub-band are known both at the encoder and the decoder side. The standard deviations which are used, may, according to embodiments, be calculated off-line, e.g. on a training set. Thus, only the exponents {sᵢ} have to be made available to a decoding end.

The probability density function of the spectral components resulting with the scaling is used in a conventional manner to infer a cumulative density function that engenders the companding function. By way of example, the cumulative density function is extracted from a training data set and is stored as a table of 700 2-dimensional points (x,f(x)). ‘x’ is linear on portions (having 3 different slopes) so the storage of the function can be realized using 1 dimensional points (only f(x)).

Within the companding lattice vector quantizer unit 16, the scaled spectral components are companded using the engendered companding function. After companding, the companded data has almost a uniform distribution and can be efficiently quantized using a lattice quantizer.

To increase the quantization resolution, the companded data can additionally be multiplied before quantization by another, third scaling factor, which may be the standard deviation of the corresponding sub-band times a factor equal to 3 for bitrates greater or equal to 48 kbits/s, and equal to 2.1 for bitrates less than 48 kbits/s.

The quantization resolution can thus be changed by means of two parameters within the same coding structure, namely the base b of the first scaling factor and the multiplicative third scaling factor that is applied immediately before quantization. This allows the use of the same codec for different bitrate domains from, for example 16 kbit/s to 128 kbits/s at 44.1 kHz, for instance.

For the quantization of the companded data, companding lattice vector quantizer 16 is moreover adapted to use a rectangular truncated Zn lattice vector quantizer for each spectral sub-band, for example at each 1024 length quantization frame. Besides the Zn lattice, other lattices are as well applicable and within the scope of this application. The dimension of the respective Zn lattice may be equal to the number of spectral components in the respective sub-band.

A Zn lattice contains all integer coordinate points of the n-dimensional space. A finite truncation of the lattice forms a ‘codebook’ and one point can be named ‘codevector’. Each codevector can be associated to a respective index. On the other hand, the quantized spectral components of a respective sub-band can be represented by a vector of integers, which corresponds to a particular codevector of a Zn lattice quantizer. Thus, instead of encoding each vector component separately, a single index may be generated from the lattice and sent for the vector.

In a truncated lattice, the number of points of the lattice is limited. A rectangular truncated lattice, in which the vector is included, allows for a simple indexing algorithm. The lattice codevectors are then the points from the lattice truncation.

If the truncation is rectangular, the norm corresponding to this truncation can be the maximum absolute value of the components of the considered vector:

$$N ( x ) = {max}_{l} ( \vert {x}_{l} \vert ) , x = ( {x}_{1} , … , {x}_{n} ) ∈ {Z}_{n} . \qquad ( 1 )$$

The output of companding lattice vector quantizer 16 comprises the lattice codevectors indexes {cIⱼ⁽ⁱ⁾} and the norms {cnⱼ⁽ⁱ⁾} of the codevectors, which may be integers from 0 to 141. The index i denotes the sub-band and the index j enumerates the possible exponent values used in the bitrate minimization algorithm.

The presented quantization can be used as it is for spectral quantization of audio signals, or adapted to the quantization of other type of data.

The norms {cnⱼ⁽ⁱ⁾} and the exponents {sᵢ} may be entropy encoded in the entropy encoder 13 using Shannon code or an arithmetic code, to name some examples.

The bitstream output by an encoder 2 implementing the proposed spectral quantization method consists for each sub-band of the binary representation of the index of the codevector, and of the entropy encoded norm and exponent.

If the norm of a codevector is zero, the exponent of the scale factor must not be encoded, because it does not matter anymore.

The number of bits required for respective indexes {cIⱼ⁽ⁱ⁾} can be calculated as:
Nbits=|log₂ [(2cnⱼ⁽ⁱ⁾+1)ⁿ−(2cnⱼ⁽ⁱ⁾−1)ⁿ]|cnⱼ⁽ⁱ⁾>0, (2)
where n is the dimension of the quantization space, i.e. of the current sub-band and ┌·┐.represents the closest integer to the argument rounded toward infinity.

The encoder has an available total bitrate that may be set for example by the user, and the bitstream output by the encoder should have that bitrate.

In order to determine suitable exponents {sᵢ}, the scaling unit 6 may perform a distortion/bitrate optimization by applying an optimization algorithm.

To this end, the exponents {sᵢ} for each of the sub-band having a dimension of n can be initialized with
└log_{b}\sqrt{aD/n}┘−3 (3),
where aD is the allowed distortion per sub-band. The allowed distortion can be obtained from the underlying perceptual model. └·┘ represents the integer part, or the closest smaller integer to the argument. The distortion measure is the ratio between the Euclidean distortion of quantization per sub-band to the allowed distortion for the considered sub-band.

For each sub-band SBᵢ, up to 20 (as an example, different values are possible) exponent values are selected for evaluation. These exponents comprise the 19 exponent values larger than the initial one, plus the initial one. If there are not 20 exponent values larger than the initial value, then only those available are considered. It has to be noted that these numbers can also be changed, but if more values are considered the encoding time increases. Reciprocally, the encoding time could be decreased by considering fewer values, with a slight payoff in coding quality.

For each sub-band and for each considered value of the exponents, the above described process of scaling, companding, multiplication and quantization is applied for a given frame. In each of these cases, a quantized vector is obtained per sub-band and per considered exponent.

In order to encode the resulting vector a number of bits Rₘₐₓ is needed plus the number of bits to encode the max norm of the vector and the number of bits to encode the considered exponent. The sum of these three quantities corresponds to the so-called bitrate value.

A rate-distortion measure can be the error ratio with respect to the allowed distortion per subband. When calculating the error ratio, there are two possible approaches: one is to calculate the real error ratio from its definition, and the second one is to set the error ratio to zero if the allowed distortion measure is larger than the energy of the signal in the considered sub-band. The first approach can be considered as “definition” and the second as “modified definition”.

Therefore, for each subband and for each considered exponent, a respective pair of bitrate and error ratio can be obtained. This pair is also referred to as rate-distortion measure.

For each sub-band the rate-distortion measures are sorted such that the bitrate is increasing. Normally, as the bitrate increases, the distortion should decrease. In case this rule is violated, the distortion measure with the higher bitrate is eliminated. This is why not all the sub-bands have the same number of rate-distortion measures.

The optimization algorithm has two types of initializations.
1. Starting with the rate-distortion measures corresponding to the lowest error ratios, which is equivalent to the highest bitrates, or
2. Starting with the rate-distortion measure that corresponds to an error ratio less than 1.0 for all the sub-bands.

The goal of the optimization algorithm is to choose the exponent value out of the considered exponent values, for each sub-band of a current frame, such that the cumulated bitrate of the chosen rate-distortion measures is less than or equal to the available bitrate for the frame, and the overall error ratio is as small as possible. The criterion used for this optimization is the error ratio which should be minimal, while the bitrate should be within the available number of bits given by the bit pool mechanism like in AAC.

According to an exemplary optimization algorithm, the rate-distortion measures are ordered with increasing value of bitrate along the sub-bands i, i=1:N, from 1 to R_{i,Ni} and consequently decreasing error ratio, D_{i,j} i=1:N, j=1:Ni. The algorithm is initialized with the rate-distortion measures having a minimum distortion. The initial bitrate is

$$R = {\sum }_{i}^{n} {R}_{i , Ni} .$$

For selecting the best rate-distortion measure with index k, the following pseudo code can be applied:

| For i=1:N k(i) = Ni | |
|---|---|
| 1. | If R < Rₘₐₓ Stop |
| 2 | Else |
| | While (1) |
| 4 | For i = 1:n |
| 5 | If k(i) > 1 |
| | Grad(i) = (R_{i,k(i)} −R_{i,k(i)-1})/ |
| | (D_{i,k(i)-1} − D_{i,k(i)})); |
| | End For |
| 8 | i_change = arg(max(Grad)); |
| 9 | R = R − Rᵢ_{_{—}}_{change, k(i}_{_{—}}_{change)} + |
| | Rᵢ_{_{—}}_{change,k(i}_{_{—}}_{change)-1} |
| 10 | k(i_change) = k(i_change)−1; |
| 11 | If R < Rₘₐₓ Stop, Output k |
| 12 | End While |

The indexes k(i), i=1:N, point to a rate-distortion measure, but also to an exponent value that should be chosen for each sub-band, which is the one that may be used to engender the rate-distortion measure.

For high bitrates, e.g. >=48 kbits/s, the algorithm can be modified at line 5 to
if k(i) >2
such that the sub-band i is not considered at the maximization process if, by reducing its bitrate, all the coefficients are set to zero and the bitrate for that subband becomes 1.

If the total bitrate is too high, it should be decreased somehow, therefore, some of the sub-bands should have a smaller bitrate. If the only rate-distortion measure available for one subband is the one with bitrate equal to 1—which is the smallest possible value for the bitrate of a sub-band, corresponding to all the coefficients in that sub-band being set to zero—, then in that subband the bitrate cannot be further decreased. This is the reason for the test if k(i)>1. For each eligible sub-band, the gradient corresponding to the advancement of one pair to the left is calculated, and the one having maximum decrease in bitrate with lowest increase in distortion is selected. Then, the resulting total bitrate is checked, and so on.

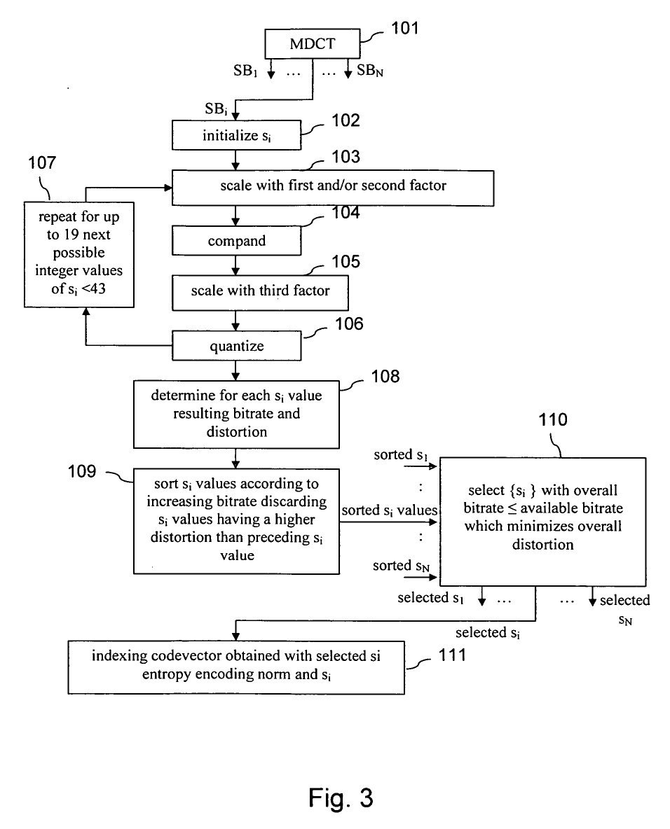

FIG. 3 is a flow chart summarizing the described encoding.

First, received audio signals are transformed and split into a plurality of sub-bands SBᵢ, with i=1 to N (step 101).

For each sub-band, an initial value of an exponent sᵢ is then determined based on an allowed distortion in this sub-band (step 102). The sub-band components are divided by the first and/or the second scaling factor, which may be the standard deviation σ and b^{s}^{ᵢ} using the determined initial value of sᵢ (step 103), companded (step 104), further scaled (step 105) with a third scaling factor and quantized (step 106) as described above. The same operations are repeated for up to 19 further values of sᵢ, sᵢ being incremented in each repetition by 1, as long as the value does not exceed 42 (steps 107, 103-106). For each of the used sᵢ values, the resulting bitrate and the resulting distortion is determined (step 108). The sᵢ values are then sorted according to an increasing associated bitrate (step 109). Those sᵢ values resulting in a higher distortion that the respective preceding sᵢ value are discarded.

Next, the sorted sᵢ values for all sub-bands are evaluated in common. More specifically, one sᵢ value is selected for each sub-band such that the set of sᵢ values {sᵢ} for all sub-bands results in a total bitrate that is as close as possible to the allowed total bitrate, and which minimizes at the same time the overall distortion (step 110).

Finally, for each sub-band SBᵢ the codevector that resulted in the quantization of step 106 with the selected sᵢ value is indexed, and the selected sᵢ value as well as the norm used in this quantization are entropy encoded (step 111).

FIG. 4 is a diagram of an exemplary electronic device 17, in which a low-complexity decoding according to an embodiment of the invention may be implemented. Electronic devices 1 and 17 may form together an exemplary embodiment of a system according to the invention.

The electronic device 17 comprises a decoder 18, of which the functional blocks are illustrated schematically. The decoder 18 comprises an entropy decoder 21, an inverse indexation unit 22, a decompanding unit 24, an inverse scaling unit 26, and an inverse MDCT unit 28.

An encoded bitstream 20 is received within the decoder 18. First, the norm, and the exponent of the scaling factor are extracted by the entropy decoding unit 21. There is a connector between entropy decoding unit 21 and inverse indexation unit 22. From the entropy decoding unit 21 the decoded norm is fed to the inverse indexation unit 22 informing on how many bits the index is represented. The codevector index is read from the binary word having a length given by the decoded norm according to formula (2) and fed to the inverse indexing unit 22.

The codevector is then regained within inverse indexation unit 22. The components of the code vector are used within decompanding unit 24 to obtain a decompanded set of values. The values are scaled with inverse scaling factors within inverse scaling unit 26. The scaled values are used within inverse MDCT unit 28 obtaining the desired audio signal.

The decoder 18 can be implemented in hardware (HW) and/or software (SW). As far as implemented in software, a software code stored on a computer readable medium realizes the described functions when being executed in a processing unit of the device 17.

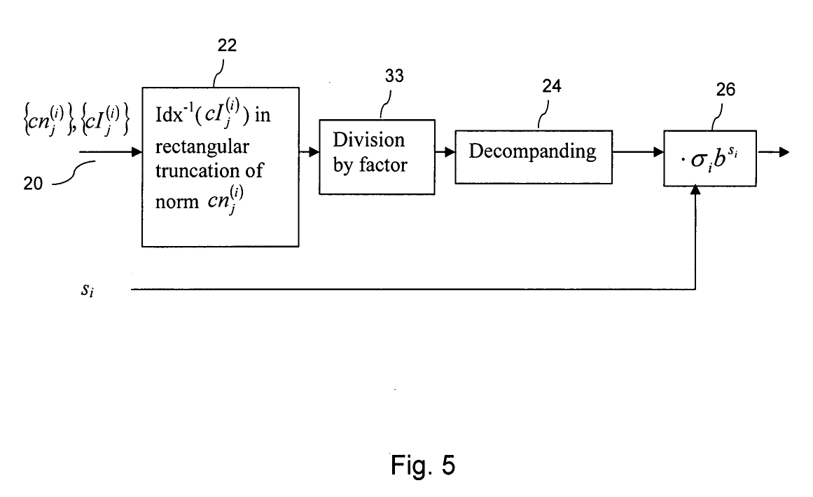

FIG. 5 illustrates selected components of a decoder 18 according to embodiments. The components comprise the inverse indexation unit 22, a scaling unit 33 (not shown in FIG. 3), the decompanding unit 24, and the modified inverse scaling unit 26.

The encoded bistream 20 comprises the codevectors index {cIⱼ⁽ⁱ⁾} for each sub-band SBᵢ, the encoded norms {cnⱼ⁽ⁱ⁾} for each sub-band SBᵢ, and the encoded exponent {sᵢ} for each sub-band SBᵢ.

The inverse indexation unit 22 utilizes the codevector indexes {cIⱼ⁽ⁱ⁾} and the decoded norms {cnⱼ^{(I)}} received from the entropy decoding unit 21 to regain the companded spectral components of each sub-band. These are divided in scaling unit 33 by a factor, which was used in the encoder 2 to multiply the companded data, namely 2.1*σᵢ or 3*σᵢ.

The resulting data is decompanded in decompanding unit 24.

The decoded exponent {sᵢ} received from the entropy decoding unit 21 is used to generate together with known base b an inverse scale factor for a respective sub-band. The inverse scale factor and the known standard deviation σᵢ for a respective sub-band, are used to re-scale the spectral components output by the decompanding unit 24 for a respective sub-band within inverse scaling unit 26.

It is to be noted that the described embodiments can be varied in many ways.

What is claimed is:

1. A method for audio encoding comprising:
receiving an input audio signal,
splitting the input audio signal into at least two sub-bands,
scaling the at least two sub-bands with a first factor,
companding each of the at least two scaled sub-bands, and
quantizing the companded, scaled sub-bands.

2. The method of claim 1, wherein said first factor depends on at least one of
A) a total bitrate which is available for an encoded data stream,
B) an available bitrate for each subband, and
C) properties of a respective sub-band.

3. The method of claim 1, wherein said scaling further comprises scaling the at least two sub-bands with a second factor depending at least on a standard deviation of the respective scaled sub-band.

4. The method of claim 1, wherein quantization comprises quantizing using a lattice quantizer.

5. The method of claim 1, wherein said first factor comprises a base and an exponent, and wherein said base for a respective sub-band is set to a lower value for an overall higher bitrate and to a higher value for an overall lower bitrate.

6. The method of claim 1, wherein said first factor comprises a base and an exponent, and wherein said exponent is determined for each sub-band such that the total bitrate of the encoded audio signal is as close as possible to an available bitrate, and that an overall error ratio in all sub-bands is minimized.

7. The method of claim 1, wherein said first factor comprises a base and an exponent, and wherein said exponent is determined at least from a rate-distortion measure.

8. The method of claim 6, further comprising selecting as a lowest considered exponent value for the optimization for each sub-band the value:
└log_{b}\sqrt{aD/n}┘−3
where aD is the allowed distortion per sub-band, issued from a perceptual coding model, and └·┘ represents the integer part, or the closest smaller integer to the argument.

9. The method of claim 7, wherein said rate-distortion measures are sorted for each sub-band for increasing bit-rates.

10. The method of claim 7, further comprising initializing a search for a rate-distortion measure resulting in an optimized exponent with one of
A) starting with the rate-distortion measures corresponding to the lowest error ratios, which is equivalent to the highest bitrates, or
B) starting with the rate-distortion measure that corresponds to an error ratio less than 1.0 for all sub-bands.

11. The method of claim 7, wherein said rate-distortion measure is the error ratio with respect to the allowed distortion per subband, said error ratio being calculated with at least one of
A) calculating a real error ratio from its definition, or
B) setting the error ratio to zero if the allowed distortion measure is larger than the energy of the signal in the considered sub-band.

12. The method of claim 1, further comprising encoding at least a component of said first factor using entropy encoding.

13. The method of claim 1, further comprising utilizing the probability function of the scaled sub-bands for creating a cumulative density function for companding.

14. The method of claim 1, further comprising scaling the companded sub-bands before quantization with a third scaling factor, wherein the third scaling factor is higher for higher bitrates than for lower bitrates.

15. The method of claim 1, using a rectangular truncated lattice for quantizing the companded, scaled sub-bands, the quantization resulting in a codevector for each sub-band.

16. The method of claim 15, further comprising calculating for each sub-band a norm for a lattice truncation which includes the quantized sub-band, encoding the calculated norm for each sub-band using entropy encoding, and encoding the codevectors through indexing.

17. An encoder comprising:
a transform unit adapted to receive an input audio signal and to split the input audio signal into at least two sub-bands;
a scaling unit adapted to scale at least two sub- bands with a first factor;
a companding unit adapted to compand each of at least two scaled sub-bands; and
a quantization unit adapted to quantize the companded, scaled sub-bands.

18. An electronic device comprising:
a transform unit adapted to receive an input audio signal and to split the input audio signal into at least two sub-bands;
a scaling unit adapted to scale at least two sub-bands with a first factor;
a companding unit adapted to compand each of at least two scaled sub-bands; and
a quantization unit adapted to quantize the companded, scaled sub-bands.

19. A software program product, in which a software code for audio encoding is stored in a readable memory, said software code realizing the following steps when being executed by a processing unit of an electronic device:
receiving an input audio signal,
splitting the input audio signal into at least two sub-bands,
scaling the at least two sub-bands with a first factor,
companding each of the at least two scaled sub-bands, and
quantizing the companded, scaled sub-bands.

20. A method for audio decoding comprising:
receiving encoded audio data,
generating at least two companded sub-bands from said encoded audio data,
decompanding each companded sub-band,
scaling the at least two decompanded sub-bands with a first factor, and
combining the decompanded and scaled sub-bands to a decoded audio signal.

21. A decoder comprising:
a decompanding unit adapted to decompand at least two companded sub-bands, wherein said companded sub-bands are generated from received encoded audio data;
a scaling unit adapted to scale the at least two decompanded sub-bands with a first factor; and
a transform unit adapted to combine the decompanded and scaled sub-bands to a decoded audio signal.

22. An electronic device comprising:
a decompanding unit adapted to decompand at least two companded sub-band, wherein said companded sub-band are generated from received encoded audio data;
a scaling unit adapted to scale the at least two decompanded sub-bands with a first factor; and
a transform unit adapted to combine the decompanded and scaled sub-bands to a decoded audio signal.

23. A software program product, in which a software code for audio decoding is stored in a readable memory, said software code realizing the following steps when being executed by a processing unit of an electronic device:
receiving encoded audio data,
generating at least two companded sub-bands from said encoded audio data,
decompanding each companded sub-band,
scaling the at least two decompanded sub-bands with a first factor, and
combining the decompanded and scaled sub-bands to a decoded audio signal.

24. A system comprising an encoder for encoding audio data and decoder for decoding encoded audio data, the encoder comprising:
a transform unit adapted to receive an input audio signal and to split the input audio signal into at least two sub-bands;
a scaling unit adapted to scale at least two sub-bands with a first factor;
a companding unit adapted to compand each of at least two scaled sub-bands; and
a quantization unit adapted to quantize companded, scaled sub-bands;
and the decoder comprising
a decompanding unit adapted to decompand at least two companded sub-band, wherein said companded sub-band are generated from received encoded audio data;
a scaling unit adapted to scale the at least two decompanded sub-bands with the first factor; and
a transform unit adapted to combine the decompanded and scaled sub-bands to a decoded audio signal.
